(19) United States
(12) Patent Application Publication
(10) Pub. No.: US 2026/0062150 A1
(43) Pub. Date: Mar. 5, 2026

(54) METHODS AND SYSTEMS FOR BATTERY POWERED AIRCRAFT

(71) Applicant: Kyle Bedrich, Cypress, TX (US)

(72) Inventor: Kyle Bedrich, Cypress, TX (US)

(21) Appl. No.: 19/244,856

(22) Filed: Jun. 20, 2025

Related U.S. Application Data
(60) Provisional application No. 63/689,161, filed on Aug. 30, 2024.

(51) Int. Cl. B64F 5/60; B64C 11/44; B64D 27/357; B64F 5/10; B64U 10/10; B64U 20/00; B64U 50/19; B64U 50/30

(52) U.S. Cl. CPC B64F 5/60; B64C 11/44; B64D 27/357; B64F 5/10; B64U 10/10; B64U 20/00; B64U 50/19; B64U 50/30

(57) ABSTRACT

Methods and systems relate to propulsion for aircraft that include battery-powered electric motors driving propellers. The methods may use a propulsion analysis model that connects propulsion component models and is used in a propulsion simulation. Exemplary uses of a resulting propulsion selection output from the propulsion simulation include generating a list of propulsion component combinations that may be ranked for performance, assembling the aircraft with the propulsion component combinations, designing of the propulsion components, or adjusting in real-time one or more of the propulsion components. For example, adjusting the pitch of the propeller on the aircraft based on the propulsion selection output may occur automatically by an actuator coupled to the propeller in response to the actuator receiving a command signal from the processor based on the propulsion selection output being performed during flight.

### CROSS-REFERENCE TO RELATED APPLICATIONS

This application is a nonprovisional application which claims priority from U.S. provisional application No. 63/689,161, filed Aug. 30, 2024, which is incorporated by reference herein in its entirety.

### TECHNICAL FIELD/FIELD OF THE DISCLOSURE

The present disclosure relates generally to propulsion for aircraft that include battery-powered electric motors driving propellers,

### BACKGROUND OF THE DISCLOSURE

Propeller-driven electric propulsion systems in aircraft use different batteries, motors and propellers to achieve desired aircraft design and operational functioning. Selection of such propulsion components often relies on assumptions and past approaches that fail to account for the potential millions of variables that can impact the design. Manufacturers or operators thus cannot properly assess propulsion component combinations resulting in deficiencies relating to assembling the propulsion components in the aircraft, designing one or more of the propulsion components, or adjusting in real-time one or more of the propulsion components.

### SUMMARY

A method of assembling propulsion components in an electric powered aircraft includes inputting performance criteria for the aircraft into a processor and maintaining databases in computer memory with performance characteristics of multiple batteries, multiple motors and multiple propellers. The method further includes running a propulsion analysis model with the processor using a battery model, a motor model and a propeller model each querying respective ones of the databases to generate a propulsion selection output based on the performance criteria. In addition, assembling the aircraft occurs in the method with a combination that includes one of the multiple batteries, one of the multiple motors and one of the multiple propellers as identified by the propulsion selection output.

A system for assembling propulsion components in an electric powered aircraft includes a computer processor with memory to perform steps that include obtain performance criteria for the aircraft and access databases containing performance characteristics of multiple batteries, multiple motors and multiple propellers. The processor also runs a propulsion analysis model using a battery model, a motor model and a propeller model each querying respective ones of the databases to generate a propulsion selection output based on the performance criteria. Then, the processor displays a list to a user with at least one combination that includes one of the multiple batteries, one of the multiple motors and one of the multiple propellers as identified by the propulsion selection output.

A process of controlling a propulsion component in an electric powered aircraft includes inputting performance criteria for the aircraft into a processor and maintaining databases in computer memory with performance characteristics of a battery, a motor and a propeller in the aircraft. The process further includes running a propulsion analysis model with the processor using a battery model, a motor model and a propeller model each querying respective ones of the databases to generate a propulsion selection output based on the performance criteria. In addition, adjusting pitch of the propeller on the aircraft occurs with the process based on the propulsion selection output.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic view of an electric powered aircraft having a combination of a battery, a motor and a propeller assembled in the aircraft for propulsion, in accordance with embodiments of the invention.

FIG. 2 is a flow diagram for propulsion simulation to provide a propulsion selection output, in accordance with embodiments of the invention.

FIG. 3 is a flow diagram for component models used in the propulsion simulation, in accordance with embodiments of the invention.

FIG. 4 is a flow diagram for a propulsion analysis model that connects the component models and is used in the propulsion simulation, in accordance with embodiments of the invention.

FIG. 5 is a flow diagram for a performance function that is comprehensive and used in the propulsion simulation, in accordance with embodiments of the invention.

FIG. 6 is a flow diagram for the performance function that is iterative and alternatively used in the propulsion simulation, in accordance with embodiments of the invention.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

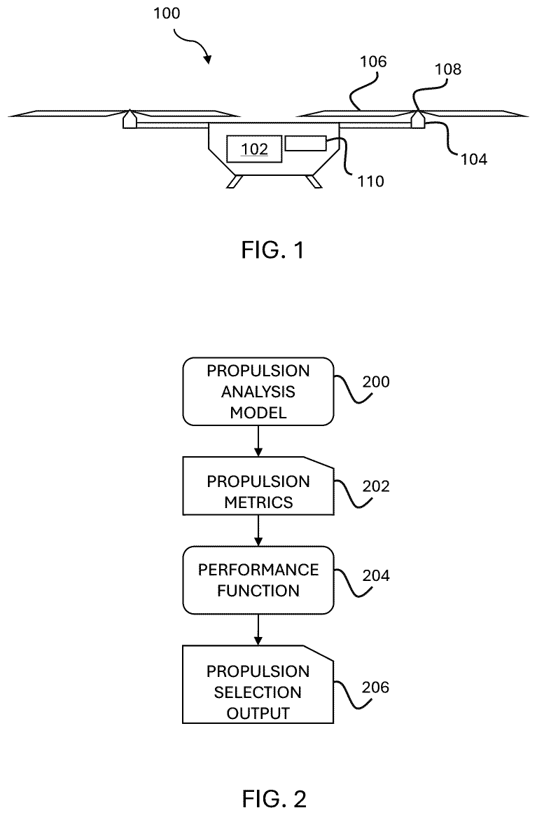

FIG. 1 shows a schematic view of an aircraft 100 that is electric powered and has a combination of a battery 102, a motor 104 and a propeller 106 assembled in the aircraft 100 for propulsion. As used herein, reference to the battery 102, the motor 104 and the propeller 106 refers to however many of each of the components are used in the aircraft 100 and thus is not intended to be limited to a singular one of each component. The aircraft 100 may be unmanned and may be single-rotor, multi-rotor and/or fixed wing.

In some embodiments, the aircraft 100 further includes a processor 110, which may be onboard as shown or part of a computer separate from the aircraft 100 that may be used in such tasks as assessing combination of the battery 102, the motor 104 and the propeller 106 for assembling into the aircraft 100 or designing one or more of the battery 102, the motor 104 and the propeller 106. An actuator 108 for some embodiments may adjust the pitch of the propeller 106 on the aircraft 100. The adjusting of the propeller 106 may occur automatically by the actuator 108 in response to the actuator 108 receiving a command signal from the processor 110 based on simulations described herein being performed in real-time during flight.

FIG. 2 depicts a flow diagram for propulsion simulation including a propulsion analysis model 200 that outputs propulsion metrics 202 for a performance function 204 to then generate a propulsion selection output 206. The propulsion analysis model 200 may simulate overall propulsion performance resulting from a propulsion system made up of components that are the battery 102, the motor 104 and the propeller 106 for multiple use cases. In general, the performance function 204 minimizes a weighted set of costs related to the propulsion system's performance, characteristics, and user performance criteria so that the propulsion selection output 206 may be used to improve a propeller's geometry, motor characteristics, and/or battery specifications. As with all models disclosed herein, the processor 110 includes memory to perform any steps associated with the propulsion analysis model 200 and the performance function 204.

The propulsion system may use off-the-shelf components, components designed from the ground up, or both. The propulsion analysis model 200 and the performance function 204 can be used to test, design, and/or improve the propulsion system. For example, the propulsion selection output 206 may be the combination of the battery 102, the motor 104 and the propeller 106 identified among multiple off-the-shelf options for each of those components that works best for the performance criteria the user wants from the aircraft 100. Examples of the performance criteria may include propulsion system thrust and torque at any user specified airspeed, efficiency, battery life duration, power draw, total propulsion system weight, propulsion system expense and propulsion system viability. As used herein, viability refers to component compatibility, within reasonable design specifications/within constraints set by the user, and individual component model accuracy at the operating point in the propulsion simulation. As such, the propulsion selection output 206 may provide the combination (i.e., the battery 102, the motor 104 and the propeller 106 selected from multiple options of each) least expensive to provide the most thrust, the combination for longest runtime, the combination capable of lifting a given payload, or the combination with least weight for a set hover time. In some embodiments, the propulsion selection output 206 may provide such combinations as a list ordered from best to worst for the performance criteria the user wants from the aircraft 100. The list may be all inclusive of every combination evaluated by the propulsion analysis model 200 or, e.g., only the top 5, 10 or 20 combinations for further review and evaluation by the user.

For some embodiments, the user may enter the performance criteria for the aircraft 100 in respective input fields on a website that then returns the combination from the propulsion selection output 206 as items in an online shopping cart with the battery 102, the motor 104 and the propeller 106 ready for checkout. The user entry on the website may further be linked to create a customized kit for the aircraft 100 with the combination of the battery 102, the motor 104 and the propeller 106 as identified by the propulsion selection output 206. The kit may be automatically created in a warehouse with multiple options of propulsion system component combinations by robots pulling the battery 102, the motor 104 and the propeller 106 as identified by the propulsion selection output 206.

The propulsion analysis model 200 may also assist in improving individual component characteristics. Individual component characteristics may be improved using the propulsion analysis model 200 and the performance function 204 to minimize a weighted set of costs associated with the propulsion system's desired performance, characteristics, and the user performance criteria. Examples of characteristics that may be improved are propeller geometry, motor electromagnetics and specifications, gear ratios, battery capacity, battery cells, and battery electrical characteristics. In some embodiments, one or more of the components of the propulsion system may be custom designed based on the propulsion selection output 206 that may thus be component designs. For example, the propulsion selection output 206 may be a geometrical shape for customized making of the propeller 106 to achieve the user performance criteria.

The propulsion analysis model 200 may also be used in the processor 110 that may connect a mechanical controller onboard the aircraft 100 to adjust the motor, propeller, or battery characteristics to minimize a weighted set of costs related to the propulsion system performance on the aircraft 100. As an example, the propulsion selection output 206 may thus be the pitch of the propeller 106 or the command signal to control the actuator 108 to adjust the pitch of the propeller 106 as determined by the propulsion analysis model 200 and the performance function 204. With mechanical control, the pitch of the propeller 106 may be adjusted by the actuator 108 to improve efficiency, thrust, or other aspects of flight performance.

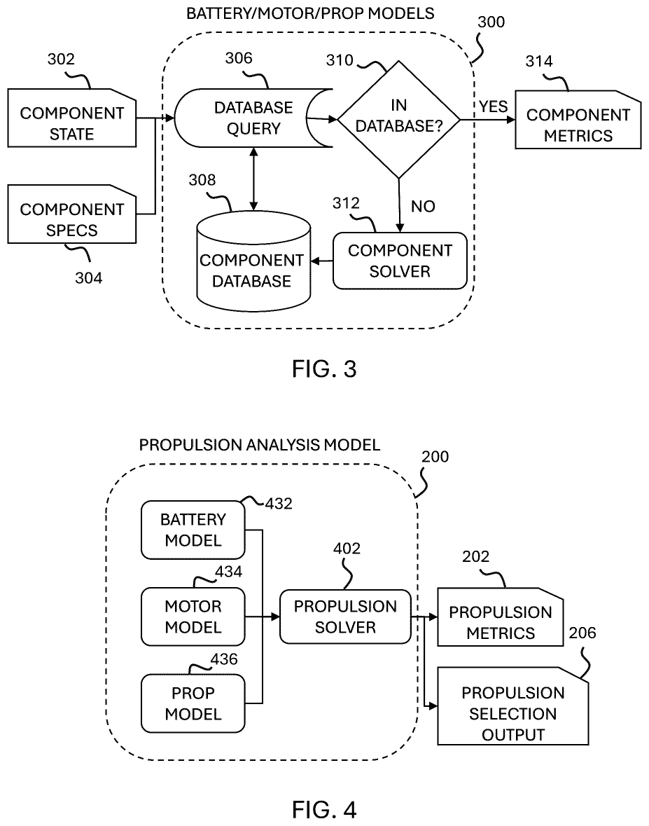

FIG. 3 illustrates a flow diagram for component models 300 used in the propulsion analysis model 200. Each component of the propulsion system, including but not limited to the battery 102, the motor 104 and the propeller 106 can be modeled using individual ones of the component models 300 based on their specifications and used in the propulsion analysis model 200. The propulsion analysis model 200 may test multiple combinations of existing batteries, motors, and propellers using data from manufacturers, component test results, the component models 300, or a combination. Further, the propulsion analysis model 200 and the performance function 204 may further consider design dynamics of the aircraft 100 (e.g., overall weight or aerodynamics of the aircraft 100) independent of outputs from the battery, motor and propeller models to generate the propulsion selection output 206.

The component models 300 as shown in FIG. 3 use component state 302 and component specifications 304 as inputs to a database query 306 accessing a component database 308 with performance characteristics at any given value of the component state 302 respectively of multiple batteries, multiple motors and multiple propellers. The performance characteristics may be preloaded into the component database 308 as part of the component specifications 304 from manufacturers of the components. The component models 300 then in a decision step 310 determines if a given query is in the component database 308 and if not determines performance characteristics via a component solver 312 for the given query of the component state and specifications 302, 304. The component solver 312 then updates the component database 308 based on direct solved values for the performance characteristics for the given query of the component state and specifications 302, 304. Alternatively, the component solver 312 may update the component database 308 based on values interpolated from existing information in the component database 308 for the performance characteristics at the given query of the component state and specifications 302, 304. For example, a regression may be created from existing information in the component database 308 to provide a torque-speed curve for a motor or propeller for use in the interpolation. Maintaining the component database 308 with information for respectively multiple batteries, multiple motors and multiple propellers makes the component models 300 able to quickly run as many scenarios (e.g., millions of scenarios) and output component metrics 314 as needed to be used in the propulsion analysis model 200.

According to some embodiments, multiple different batteries may be simulated in one of the component models 300 based on electrical and material properties, response to a load source, and environmental conditions associated with the batteries. The component models 300 for the batteries thus outputs the component metrics 314 selected from battery voltage, battery current draw, battery time to discharge and battery constraints based on the component state 302 inputs selected from battery load current, battery charge level and environmental conditions.

In some embodiments, multiple different motors may be simulated in one of the component models 300 with a controller and based on their electromagnetic and mechanical characteristics to simulate the response to an input torque and environmental conditions. The component models 300 for the motors thus outputs the component metrics 314 selected from motor power draw, motor rotational speed, motor thermals and motor constraints based on the component state 302 inputs selected from motor geometry, motor torque, motor voltage input, motor electromagnetic characteristics and the environmental conditions.

For some embodiments, multiple different propellers may be simulated in one of the component models 300 to simulate its torque and thrust given geometry, rotational speed, inlet velocity, environmental conditions, and aircraft attitude. The component models 300 for the propellers thus outputs the component metrics 314 selected from propeller torque, propeller thrust, propeller efficiency and propeller constraints based on the component state 302 inputs selected from propeller geometry, propeller rotational speed, propeller inlet velocity, aircraft attitude and the environmental conditions. As an example, the component models 300 for the propellers may determine propeller thrust output as the component metric 314 by accessing the component database 308 for each of the propellers possible in the propulsion system to obtain the propeller thrust values provided by the manufacturers for propeller rotational speeds input as the component state 302.

The simulations with the component models 300 can be as accurate as desired, where the component models 300 use as little or as many parameters for the component state 302 and/or the component metrics 314 to increase accuracy or computational speed. The component models 300 may be used to improve each component individually to meet constraints or maximize the performance criteria. The component models 300 may also be used in a time-varying (dynamic) simulation to simulate response to changing conditions.

FIG. 4 depicts a flow diagram for the propulsion analysis model 200 that connects the component models 300, which include a battery model 432, a motor model 434 and a propeller model 436. The outputs from the battery, motor and propeller models 432, 434, 436 feed into a propulsion solver 402 that may determine, for either steady state or time-varying (dynamic) simulation, the propulsion metrics 202. The propulsion solver 402 connects the battery, motor and propeller models 432, 434, 436 together using the constraints. For example, the propulsion metrics 202 may identify how changing propeller geometry will affect the overall aircraft performance given a motor and battery in real-world use cases. Combining the battery, motor and propeller models 432, 434, 436 into the propulsion analysis model 200 reduces the number of underlying assumptions when designing the propulsion system and leads to a more cohesive propulsion system and/or aircraft design.

The constraints used in the propulsion solver 402 relate how the battery, motor and propeller models 432, 434, 436 are connected to simulate the propulsion system. For example, the electric motor's rotational velocity is equal to the propeller's rotational velocity at any given point in time. In a time-varying simulation with the propulsion solver 402, the motor's and propeller's inertia are added together. In a steady-state simulation with the propulsion solver 402, the motor's and propeller's rotational velocity and torque are equal. The propulsion solver 402 makes the battery connected to the motor's controller and supplies the controller with current, and the current can be constrained in the propulsion solver 402 by the battery's low voltage limit, discharge current limit, or thermal limit at any point in its charge cycle as modeled inside the battery model 432. Each of the battery, motor and propeller models 432, 434, 436 can have its own limitations that invalidate the propulsion analysis model 200.

For some embodiments, the propulsion metrics 202 output by the propulsion analysis model 200 may be implemented in another computer software that simulates aircraft dynamics to simulate propulsion system performance in real-world flight or mission, which may be used to improve the selection of propulsion system components by minimizing a weighted set of costs to improve the flight or mission performance. Other computer software using the propulsion analysis model 200 may consider mission aspects such as aircraft takeoff, climb out, cruise, loiter, and landing performance.

The propulsion analysis model 200 may also be used to minimize a weighted set of costs related to the propulsion system's performance and the user performance criteria. The costs associated with the propulsion solver 402 and/or the performance function 204 may be related to the mission or propulsion system performance. Constraints for any component may be implemented in the component models 300 and/or the propulsion analysis model 200, assisting with selection and/or improving other components in the propulsion system.

With reference to FIG. 2, the performance function 204 may be a separate aspect as depicted independent from the propulsion analysis model 200. However, some embodiments may integrate the performance function 204 into the propulsion solver 402 of the propulsion analysis model 200. The propulsion solver 402 may thereby implement any of the costs or the user performance criteria such that the propulsion analysis model 200 itself may output the propulsion selection output 206 as depicted in FIG. 4.

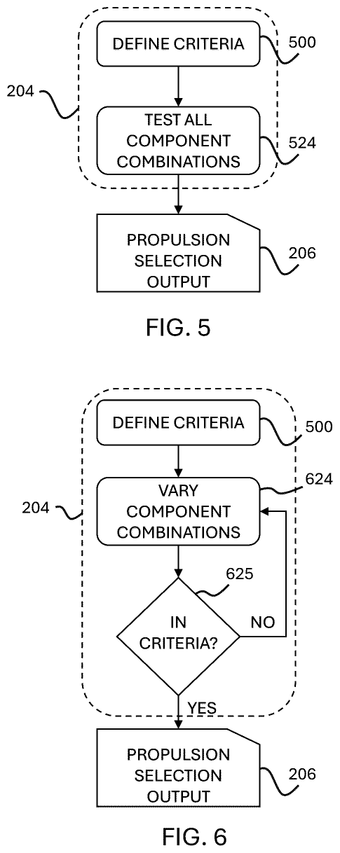

FIG. 5 illustrates a flow diagram for the performance function 204 that is comprehensive. The user defines the performance criteria in input step 500. During evaluation step 524, the propulsion analysis model 200 is run for testing all combinations of every component contained in each of the component database 308 to make up the propulsion system. The evaluation step 524 then also returns the propulsion selection output 206 based on the cost minimization/maximization applied to all the combinations that were tested.

FIG. 6 depicts a flow diagram for the performance function 204 that alternatively is iterative. The user still defines the performance criteria in the input step 500. For iteration step 624, the propulsion analysis model 200 is run for testing successive combinations of components contained in each of the component database 308 to make up the propulsion system. A rerun step 625 determines if output of the iteration step 624 is within the performance criteria selected in the input step 500 and, if not, returns the performance function 204 back to the iteration step 624. Once the rerun step 625 identifies the output of the iteration step 624 is within the performance criteria selected in the input step 500, the performance function 204 exits with the propulsion selection output 206 based on the iteration applied to less than all possible combinations for the propulsion system.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A method of assembling propulsion components in an electric powered aircraft, comprising:
inputting performance criteria for the aircraft into a processor;
maintaining databases in computer memory with performance characteristics of multiple batteries, multiple motors and multiple propellers;
running a propulsion analysis model with the processor using a battery model, a motor model and a propeller model each querying respective ones of the databases to generate a propulsion selection output based on the performance criteria; and
assembling the aircraft with a combination that includes one of the multiple batteries, one of the multiple motors and one of the multiple propellers as identified by the propulsion selection output.

2. The method of claim 1, wherein the maintaining of the databases includes determining the performance characteristics for a given component specification and state are not in the databases and updating the databases based on direct solved values for the performance characteristics of the given component specification and state.

3. The method of claim 1, wherein the maintaining of the databases includes determining the performance characteristics for a given component specification and state are not in the databases and updating the databases with values interpolated from existing information in the databases for the performance characteristics of the given component specification and state.

4. The method of claim 1, wherein the maintaining of the databases includes inputting manufacturer specifications for the multiple batteries, the multiple motors and the multiple propellers.

5. The method of claim 1, wherein the battery model outputs battery metrics selected from battery voltage, battery current draw, battery time to discharge and battery constraints based on battery state inputs selected from battery load current, battery charge level and environmental conditions.

6. The method of claim 1, wherein the motor model outputs motor metrics selected from motor power draw, motor rotational speed, motor thermals and motor constraints based on motor state inputs selected from motor torque, motor voltage input, motor electromagnetic characteristics and environmental conditions.

7. The method of claim 1, wherein the propeller model outputs propeller metrics selected from propeller torque, propeller thrust, propeller efficiency and propeller constraints based on propeller state inputs selected from propeller geometry, propeller rotational speed, propeller inlet velocity, aircraft attitude and environmental conditions.

8. The method of claim 1, wherein the performance criteria for the aircraft are selected from thrust, torque, efficiency, battery life duration, power draw, propulsion system weight, propulsion system expense and propulsion system viability.

9. The method of claim 1, wherein:
the battery model outputs battery metrics selected from battery voltage, battery current draw, battery time to discharge and battery constraints based on battery state inputs selected from battery load current, battery charge level and environmental conditions;
the motor model outputs motor metrics selected from motor power draw, motor rotational speed, motor thermals and motor constraints based on motor state inputs selected from motor torque, motor voltage input, motor electromagnetic characteristics and the environmental conditions;
the propeller model outputs propeller metrics selected from propeller torque, propeller thrust, propeller efficiency and propeller constraints based on propeller state inputs selected from propeller geometry, propeller rotational speed, propeller inlet velocity, aircraft attitude and the environmental conditions; and
the performance criteria for the aircraft are selected from thrust, torque, efficiency, battery life duration, power draw, propulsion system weight, propulsion system expense and propulsion system viability.

10. The method of claim 1, wherein the propulsion analysis model further considers design dynamics of the aircraft independent of outputs from the battery, motor and propeller models to generate the propulsion selection output.

11. The method of claim 1, wherein the propulsion analysis model uses a time-varying solver to simulate response to changing conditions.

12. The method of claim 1, further comprising adjusting based on the propulsion selection output a pitch of the one of the multiple propellers used in the assembling of the aircraft.

13. The method of claim 1, further comprising adjusting based on the propulsion selection output a pitch of the one of the multiple propellers used in the assembling of the aircraft, wherein the adjusting is automatically performed by an actuator in response to the actuator receiving from the processor located onboard the aircraft a command signal based on the propulsion selection output being performed in real-time during flight.

14. A system for assembling propulsion components in an electric powered aircraft, comprising:
a computer processor with memory to perform steps that include:
obtain performance criteria for the aircraft;
access databases containing performance characteristics of multiple batteries, multiple motors and multiple propellers;
run a propulsion analysis model using a battery model, a motor model and a propeller model each querying respective ones of the databases to generate a propulsion selection output based on the performance criteria; and
display a list to a user with at least one combination that includes one of the multiple batteries, one of the multiple motors and one of the multiple propellers as identified by the propulsion selection output.

15. The system of claim 14, wherein the computer processor with memory further performs maintenance of the databases by determining the performance characteristics for a given component specification and state are not in the databases and updating the databases based on direct solved values for the performance characteristics of the given component specification and state.

16. The system of claim 14, wherein the computer processor with memory further performs maintenance of the databases by determining the performance characteristics for a given component specification and state are not in the databases and updating the databases with values interpolated from existing information in the databases for the performance characteristics of the given component specification and state.

17. The system of claim 14, wherein:
the battery model outputs battery metrics selected from battery voltage, battery current draw, battery time to discharge and battery constraints based on battery state inputs selected from battery load current, battery charge level and environmental conditions;
the motor model outputs motor metrics selected from motor power draw, motor rotational speed, motor thermals and motor constraints based on motor state inputs selected from motor torque, motor voltage input, motor electromagnetic characteristics and the environmental conditions;
the propeller model outputs propeller metrics selected from propeller torque, propeller thrust, propeller efficiency and propeller constraints based on propeller state inputs selected from propeller geometry, propeller rotational speed, propeller inlet velocity, aircraft attitude and the environmental conditions; and
the performance criteria for the aircraft are selected from thrust, torque, efficiency, battery life duration, power draw, propulsion system weight, propulsion system expense and propulsion system viability.

18. A process of controlling a propulsion component in an electric powered aircraft, comprising:
inputting performance criteria for the aircraft into a processor;
maintaining databases in computer memory with performance characteristics of a battery, a motor and a propeller in the aircraft;
running a propulsion analysis model with the processor using a battery model, a motor model and a propeller model each querying respective ones of the databases to generate a propulsion selection output based on the performance criteria; and
adjusting a pitch of the propeller on the aircraft based on the propulsion selection output.

19. The process of claim 18, wherein the adjusting is automatically performed by an actuator coupled to the propeller in response to the actuator receiving a command signal from the processor based on the propulsion selection output being performed in real-time during flight.

20. The process of claim 18, wherein:
the battery model outputs battery metrics selected from battery voltage, battery current draw, battery time to discharge and battery constraints based on battery state inputs selected from battery load current, battery charge level and environmental conditions;
the motor model outputs motor metrics selected from motor power draw, motor rotational speed, motor thermals and motor constraints based on motor state inputs selected from motor torque, motor voltage input, motor electromagnetic characteristics and the environmental conditions; and
the propeller model outputs propeller metrics selected from propeller torque, propeller thrust, propeller efficiency and propeller constraints based on propeller state inputs selected from propeller geometry, propeller rotational speed, propeller inlet velocity, aircraft attitude and the environmental conditions.
